(19) United States
(12) Patent Application Publication
(10) Pub. No.: US 2010/0187774 A1
(43) Pub. Date: Jul. 29, 2010

(54) SEAL BARRIER FOR A MICRO COMPONENT AND METHOD FOR PRODUCING SUCH A BARRIER

(75) Inventors: Frédéric SANCHETTE, Montferrat (FR); Cédric Ducros, Bevenais (FR); Steve Martin, Saint Sauveur (FR)

Correspondence Address: BURR & BROWN, 101 South Salina Street, Seventh Floor, Syracuse, NY, 13202, US

(73) Assignee: Commissariat A L'Energie Atomique, Paris (FR)

(21) Appl. No.: 12/645,592

(22) Filed: Dec. 23, 2009

(30) Foreign Application Priority Data
Jan. 26, 2009 (FR) 09.50437

(51) Int. Cl. F16J 15/02; B23K 31/02

(52) U.S. Cl. 277/654; 228/256

(57) ABSTRACT

This method for producing a seal barrier for a micro component comprising a stack of two thin sealing layers involves forming a fusible interlayer between two sealing layers, said fusible interlayer having a melting temperature which is lower than that of the two sealing layers and melting said interlayer.

### FIELD OF THE INVENTION

The invention relates to the field of the sealing of electronic micro components, especially their encapsulation in order to protect them against damage caused by gases or fluids.

### DESCRIPTION OF THE PRIOR ART

In some applications, electronic micro components have to be placed in a vacuum in order to protect them against gases such as oxygen and nitrogen or liquids which would otherwise damage them. Examples of such applications include voltaic cells, light-emitting diodes and lithium micro batteries.

A first possible effective solution is to bond a solid sheet of glass directly onto the electronic micro component. However, this solution is incompatible with very small surface areas, does not give the micro component any flexibility and, generally speaking, is too bulky for applications which demand further size reduction.

Because placing a sheet of solid material onto a component is restrictive in the field of microelectronics, thin-film deposition techniques are generally used to obtain the sought-after sealing properties. Nevertheless, depositing thin films by using physical or chemical deposition methods does not provide a perfect seal. In fact, a thin film obtained using such techniques usually contains gas diffusion paths due to growth defects in the actual layer at the time it is deposited. This is why spaces which are sealed by depositing a thin film are usually provided with getters which absorb gases which infiltrate into said sealed spaces through diffusion paths.

Another way of minimizing the problems associated with the existence of diffusion paths is to successively stack several thin films in order to decouple growth defects, thus lengthening the diffusion paths for gas molecules as described, for example, in Documents US 2004/023847, WO 2003/069714, WO 247187 et U.S. Pat. No. 6,737,192.

Research has also been conducted on materials which comprise various layers in an attempt to minimize the inherent problems of gas diffusion paths. For example, the documents cited above also propose alternating layers of different materials and each of the documents suggests particular choices of materials (metal oxide, nitride, metal carbide, dielectric, epoxy, ceramic, etc.).

Sealing by using thin films according to the prior state of the art proves to be extremely tricky and expensive because it involves using at least a dozen layers in order to obtain leakage rates which, even then, are sometimes inadequate.

### SUMMARY OF THE INVENTION

The object of the present invention is to propose a method for producing a seal barrier for micro components which is almost perfectly leak tight and comprises a minimum number of layers even when conventional deposition techniques are used, especially physical vapor deposition.

To achieve this, the object of the invention is a method for producing a seal barrier for micro components which comprises a stack of two thin sealing films.

According to the invention, the method involves forming a fusible interlayer between the two sealing layers, said fusible interlayer having a melting temperature which is lower than that of the two sealing layers and melting said interlayer.

In other words, melting the interlayer effectively blocks the diffusion paths in the sealing layers. There is therefore no longer any need to provide dozens of deposited layers or even to provide combinations of various materials for these layers. Satisfactory sealing is thus obtained straightforwardly.

Advantageously, the fusible interlayer is made of indium.

According to another advantageous aspect of the invention, the interlayer has eutectic properties.

According to another advantageous aspect of the invention, the interlayer consists of a block of eutectic material.

The object of the invention is also a seal barrier for micro components which comprises at least one stack of two thin sealing films. According to the invention, the barrier comprises a fusible interlayer between at least two sealing layers, said fusible interlayer having a melting temperature which is lower than that of the two sealing layers.

### BRIEF DESCRIPTION OF THE DRAWINGS

The invention will be made more readily understandable by the following description which is given merely by way of example and relates to the accompanying drawings in which:

FIG. 1 is a schematic cross-sectional view of a micro component encapsulated by a seal barrier according to a first embodiment of the invention;

FIG. 2 is a schematic cross-sectional view of a micro component encapsulated by a seal barrier according to a second embodiment of the invention;

FIG. 3 is a schematic cross-sectional view of a micro component encapsulated by a seal barrier according to a third embodiment of the invention.

### DESCRIPTION OF THE PREFERRED EMBODIMENTS

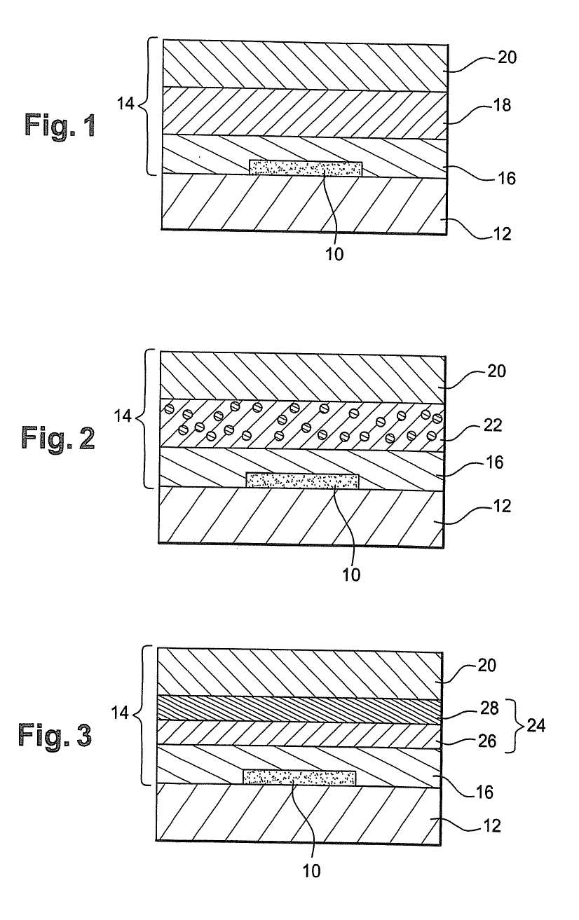

In FIG. 1, electronic micro component 10, such as a lithium micro battery, photodiode or other component, is formed on the surface of substrate 12.

A seal barrier 14 according to the invention is produced in order to seal micro component 10. This barrier 14 comprises a stack consisting of:
A first sealing layer 16 deposited on the surface of micro component 10 and covering the latter,
A fusible interlayer 18 deposited on first layer 16,
And a second sealing layer deposited on interlayer 18 so that the latter is sandwiched between sealing layers 16 and 20.

Each of layers 16, 18, 20 is successively obtained, for example, using a classic vapor or chemical deposition technique such as Physical Vapor Deposition (PVD) or Chemical Vapor Deposition (CVD).

The material from which fusible interlayer 18 is made is selected so that its melting temperature is less than the melting temperature of sealing layers 16 and 20 and lower than the stability temperature of substrate 10.

Sealing layers 16 and 20 are preferably made of a material which has a high melting temperature such as alumina (Al₂O₃), for example, which has a melting temperature of 2000° C.

Having produced stacked layers 16, 18 and 20, the device thus obtained is subjected to heating which causes interlayer 18 to melt without causing layers 16 and 20 to melt or damaging substrate 12 or component 10. For example, this heat treatment is performed inside the actual chamber used to form stacked layers 16, 18 and 20 by vacuum deposition.

The melting material of interlayer 18 then blocks any pores in layers 16 and 20 which are present due to the inherent growth defects associated with the deposition techniques used to produce layers 16, 18 and 20.

In a first version of the invention, interlayer 16 consists of a single material having a low melting temperature such as indium which has a melting temperature of 157° C.

In a second version of the invention, interlayer 16 is made of an eutectic material having a low melting point, especially a eutectic material selected from the following alloys:
Alloy of tin and indium, especially in the respective proportions 48% and 52% by weight, the alloy in these proportions having a melting temperature of 120° C.;
Alloy of tin and bismuth, especially in the respective proportions 42% and 58% by weight, the alloy in these proportions having a melting temperature of 139° C.;
Alloy of tin, lead and cadmium, especially in the respective proportions 50%, 32% and 18% by weight, the alloy in these proportions having a melting temperature of 145° C.;
Alloy of indium, lead and silver, especially in the respective proportions 80%, 15% and 5% by weight, the alloy in these proportions having a melting temperature of 149° C.;
Alloy of tin, lead and silver, especially in the respective proportions 62%, 36% and 2% by weight, the alloy in these proportions having a melting temperature of 178° C.;
Alloy of tin and lead, especially in the respective proportions 63% and 37% by weight, the alloy in these proportions having a melting temperature of 183° C.;
Alloy of tin, lead and antimony, especially in the respective proportions 63%, 36.7% and 0.3% by weight or in the respective proportions 60%, 39.7% and 0.3% by weight, the alloy in these proportions having a melting temperature of 183° C. and 188° C. respectively;
Alloy of gold and tin, especially in the respective proportions 80% and 20% by weight, the alloy in these proportions having a melting temperature of 280° C.;
Alloy of lead, tin and gold, especially in the respective proportions 93.5%, 5% and 1.5% by weight, the alloy in these proportions having a melting temperature of 301° C.; and
Alloy of bismuth, cadmium, lead and tin, especially in the respective proportions 50%, 12.5%, 25% and 12.5% by weight, the alloy in these proportions having a melting temperature of 47° C.

According to a second embodiment of the invention shown in FIG. 2, interlayer 22 formed between sealing layers 16 and 20 consists of a composite material such as, for example, solid particles of a first material involved in forming a eutectic which are embedded in a solid matrix of a second material involved in forming a eutectic, this composite material forming a eutectic which has a melting temperature that is lower than the melting temperatures of layers 16 and 20 and lower than the stability temperature of substrate 12.

According to the second embodiment, the first and second materials can be selected from the above-mentioned list. The eutectic is thus generally formed at the interfaces between the materials that form particles and the material that forms the matrix.

In a third embodiment of the invention shown in FIG. 3, interlayer 24 formed between sealing layers 16 and 20 consists of a bilayer comprising a first sublayer 26 of a first material and a second sublayer 28 of a second material with sublayers 26 and 28 being able to have different phases. The first and second materials can be selected from the above-mentioned list.

Between them, these sublayers 26 and 28 form a eutectic which has a melting temperature that is lower than the melting temperature of layers 16 and 20 and lower than the stability temperature of substrate 12. The eutectic is formed at the interface between sublayers 26 and 28.

This third embodiment can be an alternative which is easy to implement and can be used instead of the first embodiment if the alloys could be difficult to obtain.

The invention thus produces an effective seal barrier in only three layers, although several stacks as described above are feasible, depending on the applications in question. In particular, it is possible to envisage there being more than one fusible interlayer.

In one development of the invention, interlayer 18 can be formed in situ on the basis of a eutectic formed at the interface between layers 16 and 20 by heat treatment. Obviously, the materials which constitute said layers 16 and 20 are advantageously selected in order to form a eutectic having a melting temperature which is lower than that of each of the two materials such as gold or tin.

The method for producing a seal barrier according to the invention is thus especially suitable for encapsulating electronic circuits such as lithium micro batteries for instance.

In addition, there is no need to resort to non-standard materials to produce sealing layers 16 and 20 in order to ensure sealing. This allows greater latitude when choosing the materials that make up these layers which may then even fulfill additional functions other than acting as a barrier to prevent the diffusion of gases, e.g. providing a thermal barrier, protection against mechanical stresses, a protective enclosure or even electrical insulation.

Advantageously, alumina is chosen to form layers 16 and 20 because of its high melting temperature, as described above, but also because of its considerable hardness (alumina has a hardness of 20 gigapascals) and its electrical insulation and thermal protection properties. The alumina can be reactively synthesized by evaporation or sputtering titanium in an atmosphere containing oxygen or directly by evaporating or sputtering the compound as described in the literature (for example Alain BILLARD, Frédéric PERRY “Pulvérisation cathodique magnétron” [Magnetron cathode sputtering]—Techniques de l'ingénieur, M1 654).

Thus, in the context of encapsulating a lithium micro battery, one uses the following steps:
Transfer said micro battery to an encapsulation chamber or vessel and maintain said micro battery in a secondary vacuum;
Ion etching by ion bombardment in order to obtain conditioning of the last layer or upper layer of the micro battery;
Deposit the first sealing layer, in this case alumina, by PVD or CVD;
Deposit the fusible interlayer e.g. by indium evaporation;
Deposit the second sealing layer, in this case alumina, also by PVD or CVD;
Possible rise back to atmospheric pressure;
In-situ annealing in secondary vacuum at 170° C. in order to fuse the indium interlayer.

1. A method for producing a seal barrier for a micro component comprising a stack of two thin sealing layers, wherein it involves forming a fusible interlayer between two sealing layers, said fusible interlayer having a melting temperature which is lower than that of the two sealing layers and melting said interlayer.

2. The method for producing a seal barrier for a micro component as claimed in claim 1, wherein interlayer is made of indium.

3. The method for producing a seal barrier for a micro component as claimed in claim 1, wherein interlayer has eutectic properties.

4. The method for producing a seal barrier for a micro component as claimed in claim 3, wherein interlayer consists of a material selected from the following alloys:
Alloy of tin and indium, especially in the respective proportions 48% and 52% by weight;
Alloy of tin and bismuth, especially in the respective proportions 42% and 58% by weight;
Alloy of tin, lead and cadmium, especially in the respective proportions 50%, 32% and 18% by weight;
Alloy of indium, lead and silver, especially in the respective proportions 80%, 15% and 5% by weight;
Alloy of tin, lead and silver, especially in the respective proportions 62%, 36% and 2% by weight;
Alloy of tin and lead, especially in the respective proportions 63% and 37% by weight;
Alloy of tin, lead and antimony, especially in the respective proportions 63%, 36.7% and 0.3% by weight or in the respective proportions 60%, 39.7% and 0.3% by weight;
Alloy of gold and tin, especially in the respective proportions 80% and 20% by weight;
Alloy of lead, tin and gold, especially in the respective proportions 93. 5%, 5% and 1.5% by weight;
Alloy of bismuth, cadmium, lead and tin, especially in the respective proportions 50%, 12.5%, 25% and 12.5% by weight.

5. The method for producing a seal barrier for a micro component as claimed in claim 3, wherein interlayer consists of a piece of eutectic material.

6. The method for producing a seal barrier for a micro component as claimed in claim 4, wherein interlayer consists of a piece of eutectic material.

7. The method for producing a seal barrier for a micro component as claimed in claim 3, wherein interlayer is made of a composite material consisting of two materials.

8. The method for producing a seal barrier for a micro component as claimed in claim 4, wherein interlayer is made of a composite material consisting of two materials.

9. The method for producing a seal barrier for a micro component as claimed in claim 3, wherein interlayer is made of a bilayer consisting of two materials.

10. The method for producing a seal barrier for a micro component as claimed in claim 4, wherein interlayer is made of a bilayer consisting of two materials.

11. A seal barrier for a micro component comprising at least one stack of two thin sealing layers, wherein it comprises a fusible interlayer between at least two sealing layers, said fusible interlayer having a melting temperature which is lower than that of the two sealing layers.
